(19) United States
(12) Patent Application Publication
(10) Pub. No.: US 2017/0271765 A1
(43) Pub. Date: Sep. 21, 2017

(54) METAL BODY ANTENNA HAVING LOOP TYPE RADIATION ELEMENTS

(71) Applicant: ACE TECHNOLOGIES CORPORATION, Incheon (KR)

(72) Inventors: Sung Nam AN, Seoul (KR); Won Whi JIN, Bucheon-si (KR); Jun Hee KIM, Incheon (KR)

(21) Appl. No.: 15/455,242

(22) Filed: Mar. 10, 2017

(30) Foreign Application Priority Data
Mar. 18, 2016 (KR) 10-2016-0032567

(51) Int. Cl. H01Q 7/00; H01Q 5/30; H01Q 1/48

(52) U.S. Cl. CPC H01Q 7/00; H01Q 1/48; H01Q 5/30

(57) ABSTRACT

A metal body antenna using a housing unit and a battery cover as an antenna. The metal body antenna includes a radiation element supplied with a signal from a feeding power port, a ground coupled to the radiation element by loop coupling to generate an induction current, a frame bezel unit separated from the ground by a dielectric and a gap, and a connection line configured to connect the ground and the frame bezel unit and formed over the dielectric so that an electric current induced into the ground flows into the frame bezel unit, wherein an antenna having an electrical length of a half wavelength operates in a wideband. Accordingly, a bezel unit is effectively used, and a wideband and multi-band antenna structure having a radiation loss satisfies all of the Penta Band (i.e., GSM850, EGSM, DCS, PCS, and W2100), that is, bands chiefly used in mobile phones.

### CROSS-REFERENCE TO RELATED APPLICATION

This application claims priority to Korean patent application number 10-2016-0032567, filed Mar. 18, 2016, the entire disclosure of which is incorporated by reference herein.

### BACKGROUND OF THE INVENTION

1. Field of the Invention

The present invention relates to a metal body antenna having loop type radiation elements which operates in a wideband in multiple bands and, more particularly, to a metal body antenna including the housing unit of a terminal and loop type radiation elements having a wideband characteristic in multiple bands, wherein the end part of the radiation element supplied with a signal from a feeding power port formed in the housing unit is connected to a ground and the applied signal is connected to the ground by loop coupling.

2. Description of Related Art

With the recent rapid development of a communication technology, the size and weight of a communication device are reduced and performance of a communication device is further increased.

In particular, most of smart phones are rapidly evolving from the existing second-generation and third-generation communication methods, such as global system for mobile communication (GSM), code division multiple access (CDMA), and wideband CDMA (WCDMA), to a fourth-generation communication method, such as long term evolution (LTE). Furthermore, various technologies, such as Bluetooth, global positioning system (GPS), and Wi-Fi, are integrated.

A single mobile communication terminal may use a plurality of antennas to support various communication methods, but a wideband (or broadband) antenna technology capable of implementing multiple bands using a single antenna has been developed because there is a difficulty in disposing the plurality of antennas within the limited size of the terminal.

The wideband antenna technology has been proposed as a method for supporting various communication bands through the design of an antenna having a wide bandwidth. It is however impossible to improve efficiency of all of bands while implementing multiple bands based on a wide bandwidth. Furthermore, the space in various parts may be disposed is insufficient within the terminal because a wide space is required for the antenna design.

As a method for solving such a problem, a technology in which a housing unit forming an external appearance of a terminal is made of metal and the housing unit operates as an antenna was developed.

If the technology in which the housing unit operates as the antenna as described above is used, a space within the terminal can be additionally secured, more various parts can be disposed in the terminal using the additional space, and a thin type terminal design is made possible.

More specifically, antenna technologies using the housing unit as an antenna, that is, an antenna using a conductive bezel, and a metal battery cover has a disadvantage in that they have a narrow bandwidth. Accordingly, additional technologies, such as a tubable antenna technology in order to support various communication bands, have been additionally applied.

Furthermore, several problems, such as a rise of a production cost attributable to the application of the tubable antenna technologies, an increase of the design period attributable to added parts, and a rise of power consumption, are accompanied.

Accordingly, there is an urgent need for an antenna design technology which can utilize a space within the terminal as much as possible and achieve a smaller size and has a wide bandwidth even without using an additional technology by forming the casing of a housing unit forming an external appearance of the terminal using a metal material so that the housing unit operates as an antenna.

In order to solve such conventional problems, Korean Patent No. 10-1609542 entitled “Metal-Body Antenna to Operating Wideband in a Multi-Band” was proposed.

As the terminal tends to become slim, the PCB area of the terminal recently tends to be designed by avoiding parts, such as a speaker and a battery. In such a case, an extension cable is required because the feeding power port 8a of an existing antenna deviates from the area of a PCB 2a as shown in FIG. 1a, and there is a difficulty in the antenna design. In order to supplement such a disadvantage, there is a need for an antenna design in which a feeding power port 8b shown in FIG. 1b is disposed within the area of a PCB 2b.

### SUMMARY OF THE INVENTION

In accordance with an embodiment of the present invention, an object of the present invention is to provide a metal body antenna having loop type radiation elements, which has a small radiation loss and shows a wideband characteristic in multiple bands using a frame bezel unit.

In accordance with another embodiment of the present invention, another object of the present invention is to provide an antenna having loop type radiation elements and showing a wideband characteristic in multiple bands, wherein a radiation element supplied with a signal from a feeding power port is connected to a ground in a loop form without having a coupling structure in which the radiation element supplied with a signal from the feeding power port is coupled to a frame bezel unit as a radiation element connected to the ground.

In accordance with another embodiment of the present invention, another object of the present invention is to provide a metal body antenna having loop type radiation elements and showing a wideband characteristic in multiple bands, wherein a radiation element supplied with a signal from a feeding power port induces an electric current into a ground, electrical energy is concentrated on the end part of a bezel unit opened by the gap of a frame bezel unit by a surface current that flows into the frame bezel unit, that is, a radiation element connected to the ground, by the electric current induced into the ground, and magnetic energy is concentrated on a connection line that connects the frame bezel unit and the ground.

In accordance with another embodiment of the present invention, another object of the present invention is to provide a metal body antenna having loop type radiation elements and showing a wideband characteristic in multiple bands, wherein an L-C element is inserted to a feeding power port and perfect impedance matching with the antenna unit in an operating frequency band is performed.

In accordance with an embodiment of the present invention, a metal body antenna having loop type radiation elements includes a housing unit forming an external appearance of a terminal; a first antenna unit having an electrical length of a half wavelength and including a first radiation element supplied with a signal of a low frequency band from a first feeding power port formed in the housing unit, a second radiation element supplied with a signal of a high frequency band from a second feeding power port formed in the housing unit, a ground coupled to the first and the second radiation elements by loop coupling and formed in the housing unit, a connection line connected to the ground, and a bezel unit connected to the connection line and opened by a gap; and a second antenna unit having an electrical length of a half wavelength and including a bezel unit connected to the connection line and opened by a gap.

In accordance with another embodiment of the present invention, a metal body antenna having loop type radiation elements includes a radiation element supplied with a signal from a feeding power port; a ground coupled to the radiation element by loop coupling to generate an induction current; a frame bezel unit separated from the ground by a dielectric and a gap; and a connection line configured to connect the ground and the frame bezel unit and formed over the dielectric so that an electric current induced into the ground flows into the frame bezel unit, wherein a small-sized antenna having an electrical length of a half wavelength operates in a wideband.

In accordance with another embodiment of the present invention, a metal body antenna having loop type radiation elements includes a radiation element supplied with a signal from a feeding power port; a ground coupled to the radiation element by loop coupling to generate an induction current; a frame bezel unit separated from the ground by a dielectric and a gap; and a connection line configured to connect the ground and the frame bezel unit and formed over the dielectric so that an electric current induced into the ground flows into the frame bezel unit, wherein an antenna having an electrical length of a half wavelength operates in a wideband in multiple bands.

In accordance with another embodiment of the present invention, there is provided a metal body antenna having loop type radiation elements and operating in a wideband in multiple bands, the metal body antenna being formed in a housing unit of a terminal and including rectangular ground surfaces made of a metal material and a frame bezel unit surrounding outermost edge parts of the rectangular ground surfaces and having a frame made of metal, wherein the upper frame bezel unit of the housing unit includes an upper bezel unit and side bezel units. The meal body antenna includes gaps formed to maintain specific openings at locations of specific lengths from the top of the left and right side bezel units extended from end corner parts of the upper bezel unit to a bottom, an upper frame bezel unit separated by the gaps, dielectrics formed in a specific width between the rectangular ground surfaces, and the upper bezel unit and the side bezel units of the left and right frames separated from a ground by the gaps and the dielectrics. The meal body antenna further includes first and second feeding power ports formed in a specific portion adjacent to the dielectrics above the ground; a first radiation element connected to the first feeding power port, supplied with an electromagnetic signal, and having an end part disconnected at a specific height with respect to the ground; a second radiation element connected to the second feeding power port, supplied with an electromagnetic signal, and having an end part disconnected at a specific height with respect to the ground; a connection line having an electromagnetic signal coupled to the first and the second radiation elements by loop coupling so that an induction current is generated in the ground formed below the first and the second radiation elements and connected to the ground in order to connect the ground and an upper bezel unit of the upper frame bezel unit separated by the gaps and the dielectrics; and first and second antenna units each including a side bezel unit having an end part open by the gap from the upper bezel unit connected to the connection line.

In accordance with another embodiment of the present invention, a metal body antenna having loop type radiation elements and operating in a wideband in multiple bands, the metal body antenna includes a housing unit forming an external appearance of a terminal; first and second antenna units each having an electrical length of a half wavelength and including a first radiation element supplied with a signal of a low frequency band from a first feeding power port formed in the housing unit, a second radiation element supplied with a signal of a high frequency band from a second feeding power port formed in the housing unit, a ground coupled to the first and the second radiation elements by loop coupling and formed in the housing unit, a connection line connected to the ground, and frame bezel units connected to the connection line and opened by gaps; and a separate gap formed in the open frame bezel unit, separating the open frame bezel unit and the connection line dually, and transferring an electromagnetic signal to the separated open frame bezel units through the separated connection lines.

In accordance with another embodiment of the present invention, a metal body antenna having loop type radiation elements and operating in a wideband in multiple bands, the metal body antenna includes a housing unit of a terminal; a metal frame bezel unit formed in the outskirt of the housing unit; a first gap formed by cutting part of the frame bezel unit; a ground separated from part of the frame bezel unit separated by the first gap at a specific interval; a connection line including a second gap for separating the frame bezel unit separated by the first gap, electrically connecting part of the frame bezel unit separated by the second gap and the ground, and electrically connecting another part of the separated frame bezel unit and the ground; first and second radiation elements coupled to the ground by electromagnetic loop coupling; a first feeding power port formed in the housing unit, for applying a signal of a low frequency band to the first radiation element; and a second feeding power port formed in the housing unit, for applying a signal of a high frequency band to the second radiation element, wherein a signal subjected to electromagnetic loop coupling and transferred from the first radiation element to the ground is transmitted to the frame bezel unit separated by the first gap through the connection line so that electromagnetic waves are radiated, a signal subjected to electromagnetic loop coupling and transferred from the second radiation element to the ground is transmitted to another frame bezel unit separated by the second gap through the connection line so that electromagnetic waves are radiated.

In accordance with another embodiment of the present invention, a metal body antenna having loop type radiation elements and operating in a wideband in multiple bands, the metal body antenna includes a terminal housing unit; a metal frame bezel unit formed in the outskirt of the terminal housing unit; a gap formed by cutting part of the frame bezel unit; a ground electrically connected to the frame bezel unit separated by the gap and spaced apart from part of the frame bezel unit including the gap at a specific interval; a connection line connected to the ground; first and second radiation elements formed in the ground and coupled to the ground by electromagnetic loop coupling; a first feeding power port formed in the terminal housing unit, for applying a signal of a low frequency band to the first radiation element; and a second feeding power port formed in the terminal housing unit, for applying a signal of a high frequency band to the second radiation element.

In accordance with another embodiment of the present invention, a metal body antenna having loop type radiation elements and operating in a wideband in multiple bands, the metal body antenna includes a terminal housing unit; a metal frame bezel unit formed in the outskirt of the terminal housing unit; a gap formed by cutting part of the frame bezel unit; a ground spaced apart from part of the frame bezel unit separated by the gap at a specific interval; a connection line connected to the ground, wherein part of the other side of the frame bezel unit on one side separated by the gap and the ground are connected, and part of the other side of the frame bezel unit on the other side separated by the gap and the ground are connected; first and second radiation elements coupled to the ground by electromagnetic loop coupling; a first feeding power port formed in the terminal housing unit, for applying a signal of a low frequency band to the first radiation element; and a second feeding power port formed in the terminal housing unit, for applying a signal of a high frequency band to the second radiation element, wherein a signal subjected to electromagnetic loop coupling and supplied from the first radiation element to the ground is transmitted to one frame bezel unit separated by the gap connected to the ground and radiated, and a signal subjected to electromagnetic loop coupling and supplied from the second radiation element to the ground are transmitted to the other frame bezel unit separated by the gap connected to the ground and radiated.

In the metal body antenna having loop type radiation elements according to another embodiment of the present invention, the first radiation element and the second radiation element are formed on both sides of the ground based on the connection line and operate in a wideband in multiple bands.

In the metal body antenna having loop type radiation elements according to another embodiment of the present invention, an L-C element is inserted between the first and the second feeding power ports and the first and the second radiation elements so that impedance is matched and the first and the second radiation elements operate in a wideband in multiple bands.

In the metal body antenna having loop type radiation elements according to another embodiment of the present invention, the radiation element coupled to the ground by loop coupling has a small size and disposed at a specific location in a space between the end part of the frame bezel unit and the connection line.

### BRIEF DESCRIPTION OF THE DRAWINGS

FIG. 1a is a case where a radiation element according to a conventional technology is a monopole type and shows the configuration of parts of a mobile terminal.

FIG. 1b is a case where a radiation element according to an embodiment of the present invention is a loop type and shows the configuration of parts of a mobile terminal.

FIG. 2 is a plan view showing a representative structure of a metal body antenna having loop type radiation elements formed in the housing unit of the terminal in accordance with an embodiment of the present invention.

FIG. 3a is a case where the radiation element connected to a feeding power port is linear in FIG. 2 and is a detailed plan view showing an enlarged structure of the metal body antenna having loop type radiation elements.

FIG. 3b is a case where the radiation element connected to the feeding power port is linear in FIG. 2 and is a detailed perspective view showing an enlarged structure of the metal body antenna having loop type radiation elements.

FIG. 3c is a case where the radiation element connected to the feeding power port is linear in FIGS. 3a and 3b and shows a reflection loss of the metal body antenna.

FIG. 4a is a case where the radiation element connected to the feeding power port is linear and reduced in size in FIG. 2 and is a detailed plan view showing an enlarged structure of the metal body antenna having loop type radiation elements.

FIG. 4b is a case where the radiation element connected to the feeding power port is linear and reduced in size in FIG. 2 and is a detailed perspective view showing an enlarged structure of the metal body antenna having loop type radiation elements.

FIG. 4c is a case where the radiation element connected to the feeding power port is linear and reduced in size in FIGS. 4a and 4b and shows a reflection loss of the metal body antenna.

FIG. 5a is a case where the radiation element connected to the feeding power port is linear and reduced in size in FIG. 2 and is a detailed plan view showing an enlarged structure of the metal body antenna having loop type radiation elements.

FIG. 5b is a case where the radiation element connected to the feeding power port is linear and reduced in size in FIG. 2 and is a detailed perspective view showing an enlarged structure of the metal body antenna having loop type radiation elements.

FIG. 5c is a case where the radiation element connected to the feeding power port is linear and reduced in size in FIGS. 5a and 5b and shows a reflection loss of the metal body antenna.

### DETAILED DESCRIPTION OF THE EMBODIMENTS

Hereinafter, embodiments of the present invention will be described in detail with reference to the accompanying drawings. The same elements are assigned the same reference numerals. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Embodiments of a metal body antenna are described in detail below with reference to the accompanying drawings.

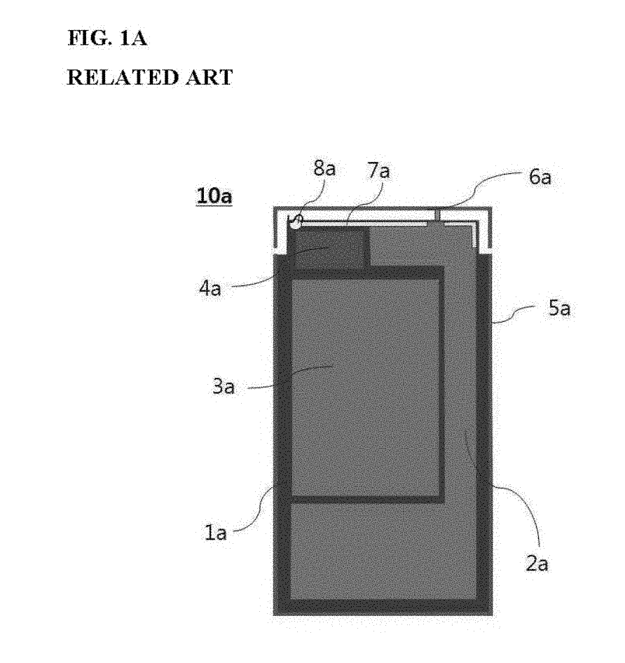

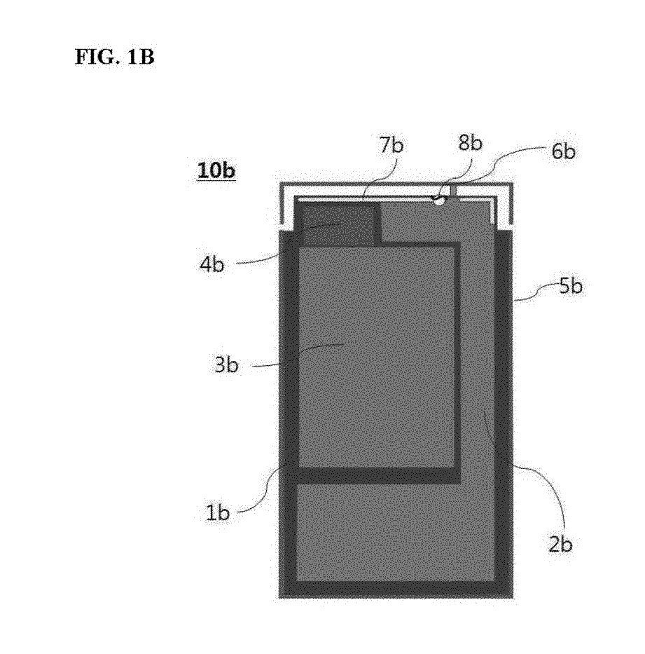

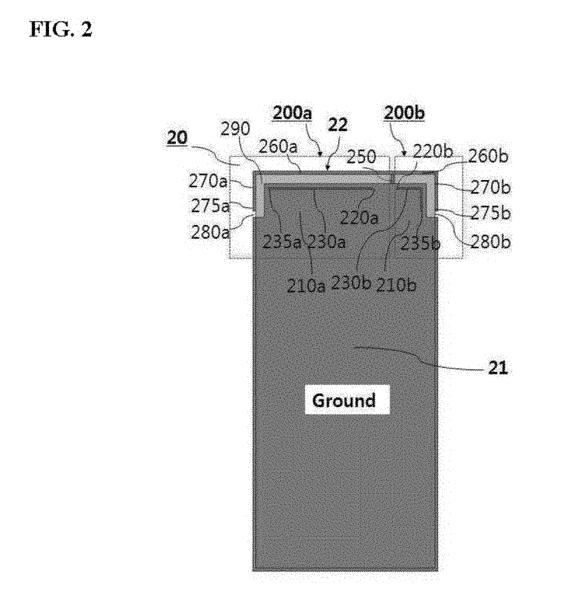

FIG. 1a is a case where a radiation element according to a conventional technology is a monopole type and shows the configuration of parts of a mobile terminal. FIG. 2 is a plan view showing a representative structure of a metal body antenna having loop type radiation elements formed in the housing unit of the terminal in accordance with an embodiment of the present invention.

Referring to FIGS. 1b and 2, the metal body antenna having loop type radiation elements according to an embodiment of the present invention is mounted on the housing unit 20 of a terminal. The housing unit 20 includes a rectangular ground 21 made of a metal material and formed to occupy most of the area of the housing unit 20 and a frame bezel unit 22 on the upper side made of a metal material and formed to surround the outermost edge part of the rectangular ground.

The ground 21 of the housing unit 20 provides a ground voltage within the terminal and may form a board on which circuit elements and parts necessary for the operation of the terminal are mounted.

More specifically, the metal body antenna formed in the housing unit 20 according to an embodiment of the present invention includes grounds 210a and 210b of a ground region on the upper side indicated by dotted lines, first and second feeding power ports 220a and 220b including two ports, two first and second radiation elements 230a and 230b, a common connection line 250, an upper bezel unit 260, that is, first and second bezel units 260a and 260b on the upper part of the frame bezel unit 22 on the upper side, first and second side bezel units 270a and 270b on the left and right sides of side units, and gaps 280a and 280b and a dielectric 290 formed in the first and the second side bezel units 270a and 270b.

Furthermore, the metal body antenna formed in the housing unit 20 according to an embodiment of the present invention includes a first antenna unit 200a operating in a low frequency band and a second antenna unit 200b operating in a high frequency band.

That is, in accordance with an embodiment of the present invention, each of the first and the second antenna units 200a and 200b is an antenna having an electrical length of a half wavelength. That is, the metal body antenna according to an embodiment of the present invention is formed dually or solely like the first antenna unit 200a and the second antenna unit 200b. The first antenna unit 200a operates in a low frequency band and the second antenna unit 200b operates in a high frequency band, and thus the metal body antenna operates in a wideband in multiple bands. The first antenna unit 200a operates at 824 MHz-960 MHz, that is, a frequency of GSM850 and EGSM of a low frequency band. The second antenna unit 200b operates at 1710 MHz 2170 MHz, that is, a frequency of DCS, PCS or W2100 of a high frequency band.

The first antenna unit 200a includes the ground 210a, the first feeding power port 220a, the first radiation element 230a, the connector line 250, the first bezel unit 260a, the first side bezel unit 270a, the gap 280a, and the dielectric 290 in the upper ground region indicated by dotted lines. Accordingly, the first antenna unit 200a is formed so that the end part 275a of the first side bezel unit 270a is opened by the gap 280a.

Furthermore, the second antenna unit 200b includes the ground 210b, the second feeding power port 220b, the second radiation element 230b, the connector line 250, the second bezel unit 260b, the second side bezel unit 270b, the gap 280b, and the dielectric 290 in the upper ground region indicated by dotted lines. Accordingly, the second antenna unit 200b is formed so that the end part 275b of the right bezel unit 270b is opened by the gap 280b.

The two first and the second feeding power ports 220a and 220b are formed to be not connected to the grounds 210a and 210b in the upper ground region indicated by dotted lines, that is, the ground 21 on the upper side which neighbors the dielectric 290, and thus function to supply an electromagnetic signal from the RF module of a terminal to the first and the second antenna units 200a and 200b.

Furthermore, in some embodiments, L-C elements are inserted into the first and the second feeding power ports 220a and 220b, respectively, so that the first and the second feeding power ports 220a and 220b are perfectly matched with the first and the second antenna units 200a and 200b in respective operating frequency bands, thereby achieving impedance matching.

The first radiation element 230a is connected to the first feeding power port 220a and supplied with an electromagnetic signal. The first radiation element 230a has a specific height and length with respect to the ground 210a and is configured to have an end part 235a disconnected.

The second radiation element 230b is connected to the second feeding power port 220b and supplied with an electromagnetic signal. The second radiation element 230b has a specific height and length with respect to the ground 210b and is configured to have an end part 235b disconnected.

The first and the second radiation elements 230a and 230b may be formed on the upper side of the ground 21 or the dielectric 290 in order to utilize the space of the housing unit 20.

Accordingly, the first and the second radiation elements 230a and 230b supplied with electromagnetic signals from the first and the second feeding power ports 220a and 220b transfer the electromagnetic signals to the grounds 210a and 210b by loop coupling.

The connection line 250 is a common connection line which connects the grounds 210a and 210b and the upper bezel unit 260 of the frame bezel unit 22. Accordingly, an electromagnetic signal is transferred from the grounds 210a and 210b to the first and the second bezel units 260a and 260b of the first and the second antenna units 200a and 200b by the connection line 250. Furthermore, the electromagnetic signal transferred by each of the first bezel unit 260a of the first antenna unit 200a and the second bezel unit 260b of the second antenna unit 200b is branched by the connection line 250.

Furthermore, in some embodiments, an L-C element may be inserted between the ground 210a or 210b and the connection line 250 in order to adjust the operating frequency of the first antenna unit 100a and the second antenna unit 200b.

Furthermore, the upper bezel unit 260 of the frame bezel unit 22 includes the first bezel unit 260a on the left side of the first antenna unit 200a and the second bezel unit 260b on the right side of the second antenna unit 200b, which surround the outermost edge parts of the rectangular ground 21 connected to the connection line 250.

In the case of the first antenna unit 200a, the first side bezel unit 270a on the left surface of the frame bezel unit 22 is vertically extended in the end corner part of the left first bezel unit 260a. In the case of the second antenna unit 200b, the second side bezel unit 270b on the right surface of the frame bezel unit 22 is also vertically extended in the end corner part of the right second bezel unit 260b.

Each of the gaps 280a and 280b is formed to maintain a specific opening at a location of a specific length from the top of each of the first and the second side bezel units 270a and 270b to the bottom. Accordingly, the gaps 280a and 280b are formed to have the open end parts 275a and 275b in the first and the second side bezel units 270a and 270b, respectively.

The dielectric 290 formed to have a specific width is provided between the rectangular ground 21 and the bezel unit 260, that is, a frame separated from the left and right surfaces by the gaps 280a and 280b.

Accordingly, the frame bezel unit 22, including the first and the second bezel units 260a and 260b of the upper bezel unit 260 and the first and the second side bezel units 270a and 270b of the bezel unit 270 of the side unit, is separated from the ground 21 by the gaps 280a and 280b and the dielectric 290.

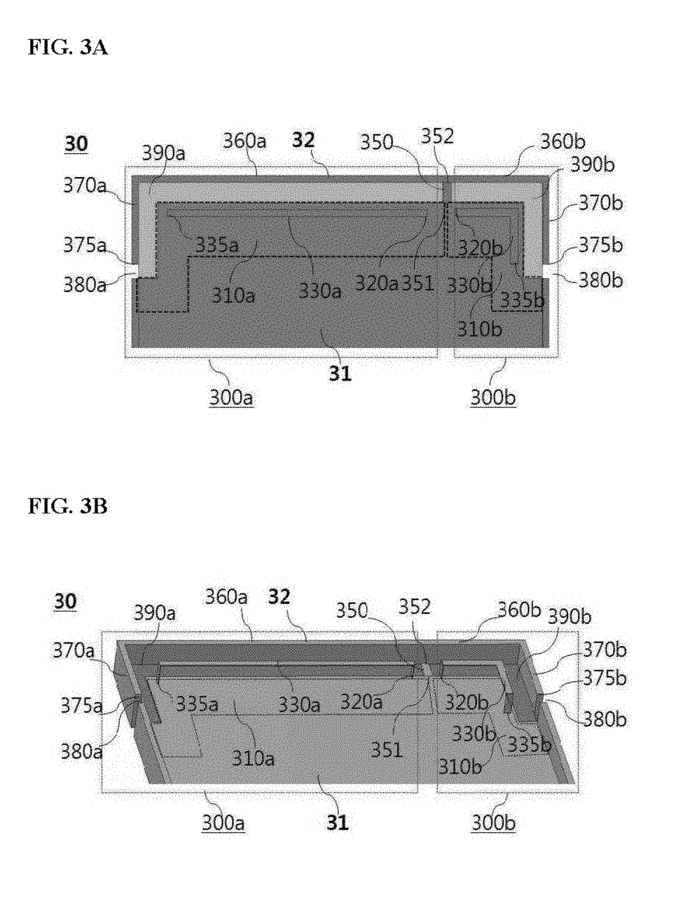

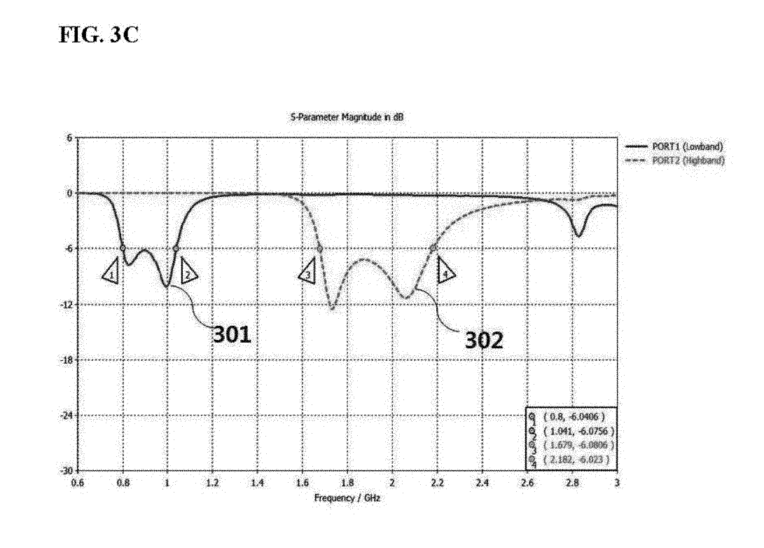

FIG. 3a is a case where the radiation element connected to the feeding power port is linear in FIG. 2 and is a detailed plan view showing an enlarged structure of the metal body antenna having loop type radiation elements. FIG. 3b is a case where the radiation element connected to the feeding power port is linear in FIG. 2 and is a detailed perspective view showing an enlarged structure of the metal body antenna having loop type radiation elements.

The metal body antenna according to an embodiment of the present invention is described in detail with reference to FIGS. 2 and 3a and 3b.

The metal body antenna formed in a housing unit 30 according to an embodiment of the present invention includes grounds 310a and 310b of an upper ground region indicated by dotted lines, first and second feeding power ports 320a and 320b including two ports, two first and second radiation elements 330a and 330b, a common connection line 350, a bezel unit 360, that is, first and second bezel units 360a and 360b on the upper part, first and second side bezel units 370a and 370b on the left and right side of a side unit, first and second gaps 380a and 380b formed in the first and the second side bezel units 370a and 370b, respectively, and dielectrics 390a and 390b.

In accordance with an embodiment of the present invention, FIG. 3a relates to a metal body antenna having a linear structure in which the first and the second radiation elements 330a and 330b are the radiation elements connected to the feeding power ports in FIG. 2. Accordingly, in some embodiments, the first and the second radiation elements 330a and 330b in the structure of FIGS. 3a and 3b are also called first and second linear radiation elements 330a and 330b.

The metal body antenna formed in the housing unit 30 according to an embodiment of the present invention includes a first antenna unit 300a operating in a low frequency band and a second antenna unit 300b operating in a high frequency band.

That is, in accordance with an embodiment of the present invention, each of the first and the second antenna units 300a and 300b is an antenna having an electrical length of a half wavelength. The metal body antenna according to an embodiment of the present invention is a loop type antenna having a dual structure, such as the first antenna unit 300a and the second antenna unit 300b. The first antenna unit 300a operates in a low frequency band and the second antenna unit 300b operates in a high frequency band, thus operating in a wideband in multiple bands. The first antenna unit 300a operates at 824 MHz˜960 MHz, that is, a frequency of GSM850 and EGSM of a low frequency band. The second antenna unit 300b operates at 1710 MHz-2170 MHz, that is, a frequency of DCS, PCS or W2100 of a high frequency band.

In the metal body antenna of FIGS. 3a and 3b according to an embodiment of the present invention, the first and the second radiation elements 330a and 330b have a linear structure, and the first bezel unit 360a and the second bezel unit 360b are supplied with an electromagnetic signal from the connection line 350 from a common location having the same start point.

The configuration of the first antenna unit 300a is described below. The first antenna unit 300a operates in a low frequency band, and includes the first linear radiation element 330a, the ground 310a of the ground region indicated by dotted lines, the connection line 350, the first bezel unit 360a, the first side bezel unit 370a, the first gap 380a, and the dielectric 390a.

The first feeding power port 320a connected to the first linear radiation element 330a is disposed at a location close to the connection line 350. The end of the first linear radiation element 330a is disconnected at a location close to the end part 375a of the first side bezel unit 370a, and supplies an electromagnetic signal of a low frequency band from the RF module of a terminal to the first antenna unit 300a.

Furthermore, in some embodiments, an L-C element is inserted into the first feeding power port 320a so that perfect matching with the first antenna unit 300a is performed in a low frequency band, thereby achieving impedance matching.

The first linear radiation element 330a is connected to the first feeding power port 320a and supplied with an electromagnetic signal. The first linear radiation element 330a is linearly formed at a specific height with respect to the ground 310a of the upper ground region and is formed to have a disconnected end part 335b.

Accordingly, when the first linear radiation element 330a supplied with the electromagnetic signal from the first feeding power port 320a transfers the electromagnetic signal to the ground 310a of the upper ground region indicated by dotted lines and located below the first linear radiation element 330a by loop coupling, an induction current is generated in the ground 310a. The disconnected end part 335a of the first linear radiation element 330a is disposed at a location close to the end part 375a of the first side bezel unit 370a.

The first radiation element 330a may be formed on the upper side of the ground 310a or the dielectric 390a in order to utilize the space of the housing unit 30. The connection line 350 is a common connection line which connects the ground 310a and the upper bezel unit 360 of a frame bezel unit 32 on the upper side. The connection line 350 connects the first connection point 351 of the ground 310a and the second connection point 352 of the upper bezel unit 360 of the frame bezel unit 32.

Furthermore, an L-C element is inserted between the ground 310a or 310b and the first connection point 351 of the connection line 350 in order to adjust the operating frequency of the first antenna unit 300a and the second antenna unit 300b.

Accordingly, an electromagnetic signal is transferred from the ground 310a to the first bezel unit 360a of the first antenna unit 300a by the connection line 350. The second connection point 352 becomes the start point of the first bezel unit 360a.

Furthermore, the first bezel unit 360a of the first antenna unit 300a is the left upper bezel unit 360 of the frame bezel unit 32 that surrounds an upper edge part in the outermost part of a rectangular ground 31 connected to the connection line 350. An electromagnetic signal transferred by the connection line 350 is branched and transferred by the second connection point 352.

The first side bezel unit 370a is located at the end corner part of the first bezel unit 360a and extended from the first bezel unit 360a in a direction vertical to the left surface of the frame bezel unit 32. The open end part 375a is formed in the first side bezel unit 370a.

The first gap 380a is formed to have a specific opening at a location of a specific length from the top of the first side bezel unit 370a to the bottom, thereby forming the open end part 375a of the first side bezel unit 370a.

The dielectric 390b formed to have a specific width is provided between the frame bezel unit 32 and the rectangular ground 31 separated by the first and the second gaps 380a and 380b.

That is, the frame bezel unit 32, including the first and the second bezel units 360a and 360b of the upper bezel unit 360 and the first and the second side bezel units 370a and 370b of the side bezel unit 370, is separated from the ground 31 by the first and the second gaps 380a and 380b and the dielectrics 390a and 390b.

Accordingly, the first antenna unit 300a is configured to include the first feeding power port 320a, that is, a first port formed in a specific portion within the area of the upper-side ground 31 in such a way as to be not connected to the ground 310a of the upper ground region adjacent to the dielectric 390a and indicated by dotted lines; the first linear radiation element 330a connected to the first feeding power port 320a, supplied with an electromagnetic signal, linearly formed in a specific height with respect to the ground 310a, and equipped with the disconnected end part 335a; the connection line 350 having an electromagnetic signal connected to the ground 310a formed below the first linear radiation element 330a by loop coupling, connected to the first ground 310a, and formed in the dielectric 390a as a connection part connected to the frame bezel unit 32 separated by the dielectric 390a and the gap 380a; and the first bezel unit 360a and the first side bezel unit 370a separated by the first gap 380a and the dielectric 390a from the upper bezel unit 360, that is, a point connected to the connection line 350, to the first gap 380a of the left frame of the frame bezel unit 32.

An operating principle according to the configuration of the first antenna unit 300a is described below.

When an electromagnetic signal is applied to the first feeding power port 320a, the first linear radiation element 330a generates an induction current by the loop coupling of electromagnetic signals along with the ground 310a. An electric current induced into the ground 310a flows into the first bezel unit 360a through the connection line 350. Electric energy is concentrated on the end part 375a of the first side bezel unit 370a due to a flow of a surface current. Magnetic energy is concentrated on the connection line 350 that connects the first bezel unit 360a and the ground 310a. The first antenna unit 300a has an electrical length of a half wavelength in an operating frequency of a low frequency band and shows a wideband characteristic as in a reflection loss indicated by a solid line 301 of FIG. 3c.

The configuration of the second antenna unit 300b is described below. The configuration and operating principle of the second antenna unit 300b are the same as those of the first antenna unit 300a other than the operating frequency.

The second antenna unit 300b is an antenna element operating in a high frequency band, and includes the second linear radiation element 330b, the ground 310b, the connection line 350, the second bezel unit 360b, the second side bezel unit 370b, and the dielectric 390b.

The second feeding power port 320b connected to the second linear radiation element 330b is disposed at a location close to the connection line 350. The end of the second linear radiation element 330b is disconnected at the place close to the end part 375b of the second side bezel unit 370b. The second linear radiation element 330b supplies a low frequency band of an electromagnetic signal from the RF module of a terminal to the second antenna unit 300b.

Furthermore, in some embodiments, an L-C element is inserted into the second feeding power port 320b so that perfect matching with the second antenna unit 300b is performed in a high frequency band, thereby achieving impedance matching.

The second linear radiation element 330b is connected to the second feeding power port 320b and supplied with an electromagnetic signal. The second linear radiation element 330b is linearly formed at a specific height with respect to the ground 310b of the upper-side ground region and is formed to have the disconnected end part 335b. Accordingly, when the second linear radiation element 330b supplied with the electromagnetic signal from the second feeding power port 320b transfers the electromagnetic signal to the ground 310b of the upper ground region indicated by dotted lines below the second linear radiation element 330b by loop coupling, an induction current is generated in the ground 310b. The disconnected end part 335b of the second linear radiation element 330b is disposed at a point close to the end part 375b of the second side bezel unit 370b.

The second radiation element 330b may be formed on the upper side of the ground 310b or the dielectric 390b in order to utilize the space of the housing unit 30.

The connection line 350 is a common connection line which connects the ground 310b and the upper bezel unit 360 of the frame bezel unit 32. The connection line 350 connects the first connection point 351 of the ground 310b and the second connection point 352 of the upper bezel unit 360 of the upper frame bezel unit.

Accordingly, an electromagnetic signal is transferred from the ground 310b to the second bezel unit 360b of the second antenna unit 300b by the connection line 350. The second connection point 352 becomes the start point of the second bezel unit 360b.

Furthermore, the second bezel unit 360b of the second antenna unit 300b is the right bezel unit of the upper bezel unit 360 that surrounds an upper edge part in the outermost part of the rectangular ground 31 connected to the connection line 350. An electromagnetic signal transferred by the connection line 350 is branched and transferred by the second connection point 352.

The second side bezel unit 370b is located at the end corner part of the second bezel unit 360b and extended from the second bezel unit 360b in a direction vertical to the right surface of the frame bezel unit 32. The open end part 375b is formed in the second side bezel unit 370b.

The second gap 380b is formed to maintain a specific opening at a location of a specific length from the top of the second side bezel unit 370b to the bottom, and thus forms the open end part 375b of the second side bezel unit 370b.

The dielectric 390b formed to have a specific width is provided between the frame bezel unit 32 and the rectangular ground 31 separated by the first and the second gaps 380a and 380b.

That is, the frame bezel unit 32, including the first and the second bezel units 360a and 360b of the upper bezel unit 360 and the first and the second side bezel units 370a and 370b of the side bezel unit 370, is separated from the ground 31 by the gap 380a and 380b and the dielectrics 390a and 390b.

Accordingly, the second antenna unit 300b includes the second feeding power port 320b, that is, a second port formed to be not connected to the ground 310b of the area of the ground 31 adjacent to the dielectric 390b and indicated by dotted lines; the second linear radiation element 330b connected to the second feeding power port 320b, supplied with an electromagnetic signal, linearly formed at a specific height with respect to the ground 310b, and equipped with the disconnected end part 335b; the connection line 350 having an electromagnetic signal connected to the ground 310a formed below the second radiation element 330b by loop coupling, connected the ground 310b, and formed in the dielectric 390b as a connection part connected to the upper bezel unit 360 of the frame bezel unit 32 separated by the dielectric 390a and the second gap 380b; and the second bezel unit 360b and the second side bezel unit 370b separated by the dielectric 390b and the second gap 380b from the upper bezel unit 360, that is, a point connected to the connection line 350, to the second gap 380b of the right frame of the upper bezel unit 360.

An operating principle according to the configuration of the second antenna is described below.

When an electromagnetic signal is applied to the second feeding power port 320b, the second linear radiation element 330b generates an induction current by the looping coupling of electromagnetic signals along with the ground 310b. An electric current induced into the ground 310b flows into the second bezel unit 360b through the connection line 350. Electric energy is concentrated on the end part 375b of the second side bezel unit 370b due to a flow of a surface current. Magnetic energy is concentrated on the connection line 350 that connects the second bezel unit 360b and the ground 310b. The second antenna unit 300b has an electrical length of a half wavelength in an operating frequency of a high frequency band and shows a wideband characteristic as in a reflection loss indicated by dotted lines 302 of FIG. 3c.

FIG. 3c is a diagram showing a reflection loss of the metal body antenna of FIGS. 3a and 3b.

Referring to FIG. 3c, the range of an operating frequency in a low frequency band is from about 800 MHz to about 1041 MHz based on a reflection loss −6 dB indicated by the solid line 301, and includes 824 MHz to 960 MHz, that is, the section of a frequency of GSM850 and EGSM. Furthermore, the range of an operating frequency in a high frequency band is from about 1679 MHz to about 2182 MHz based on a reflection loss −6 dB indicated by the dotted lines 302, and includes 1710 MHz to 2170 MHz, that is, the section of a frequency of DCS, PCS and W2100.

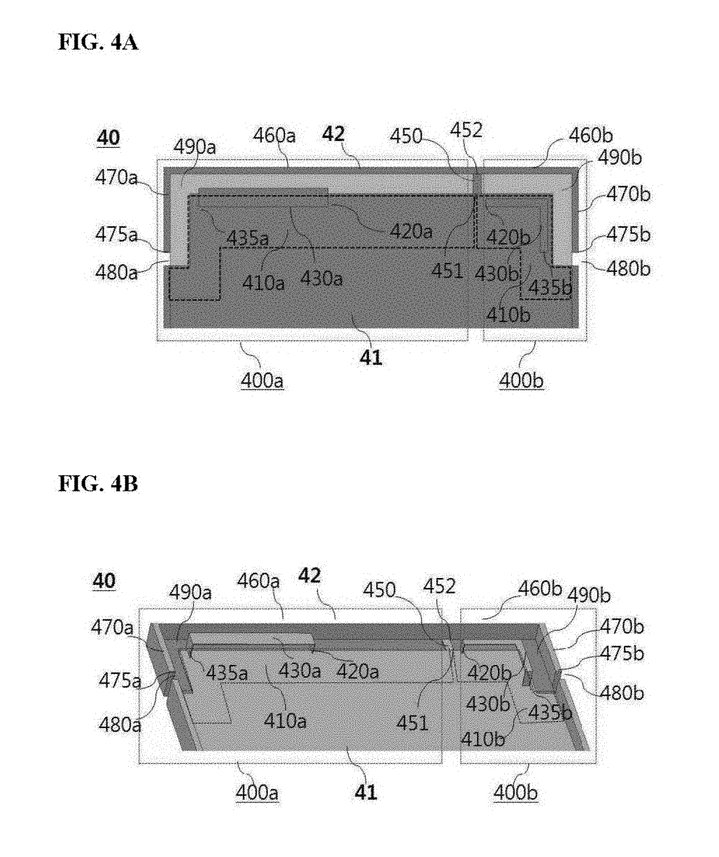

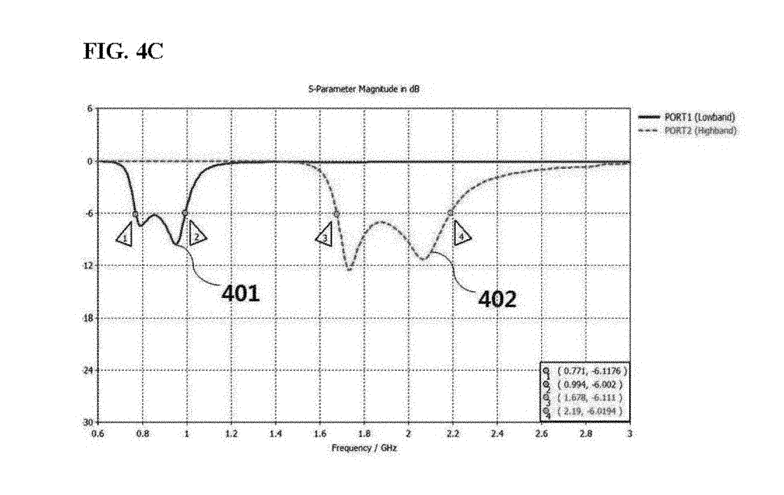

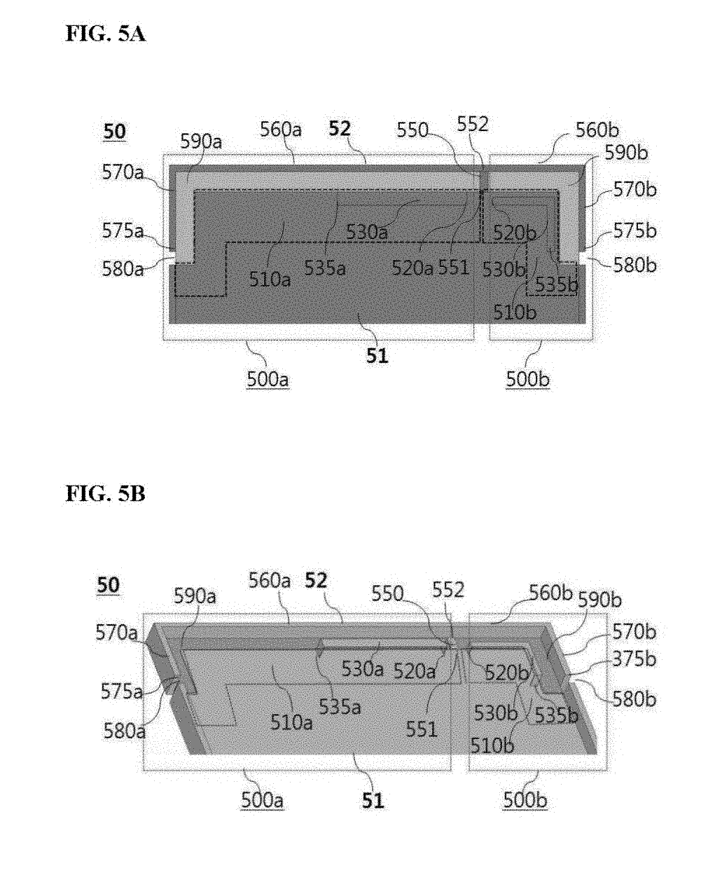

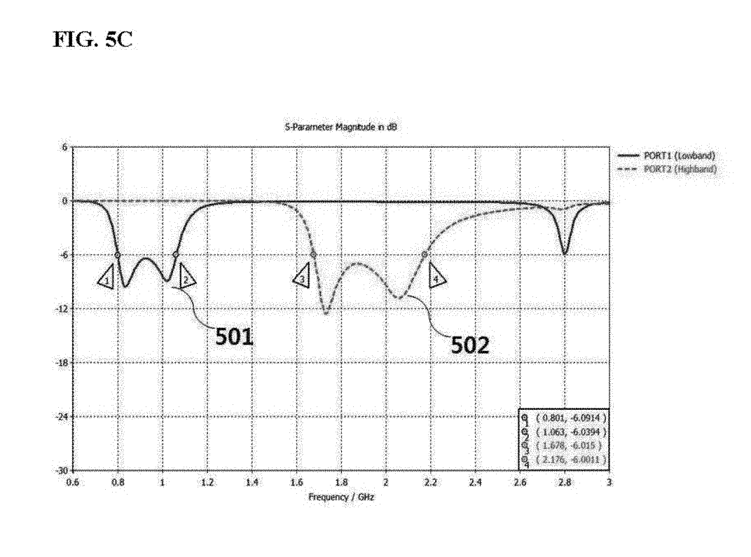

In a metal body antenna having loop type radiation elements according to another embodiment of the present invention, as in an embodiment of FIGS. 4 and 5, the loop type radiation element can be reduced in size and may be disposed at a specific location between the end part of a frame bezel unit and a connection line.

FIGS. 4a and 4b are diagrams showing the structure of an antenna according to another embodiment of the present invention. FIG. 4a is a plan view showing a detailed and enlarged structure of a metal body antenna in which the first feeding power port 420a of a first radiation element 430a is disposed between the end part 475a of a first side bezel unit 470a and a connection line 450. FIG. 4b is a perspective view showing a detailed and enlarged structure of a metal body antenna having small-sized loop type radiation elements in which the first feeding power port 420a of the first radiation element 430a is located between the end part 475a of the first side bezel unit 470a and the connection line 450.

The structure of FIGS. 4a and 4b has a small-sized antenna unit by securing a space within the housing unit 40, that is, by securing the space in which other elements and parts for a terminal are disposed.

In the metal body antenna having loop type radiation elements of FIGS. 4a and 4b according to an embodiment of the present invention, the first and the second radiation elements 430a and 430b have a small-sized linear structure, and a first bezel unit 460a and a second bezel unit 460b are supplied with an electromagnetic signal from a connection line 450 at a common location having the same start point.

Accordingly, the first radiation element 430a may be disposed in a specific location of the space between the connection line 450 and the end part 475a of the first side bezel unit 470a. The second radiation element 430b may be disposed in a specific location of the space between the connection line 450 and the end part 475b of the second side bezel unit 470b.

An operating principle of the metal body antenna using the small-sized radiation elements shown in FIGS. 4a and 4b is the same as that of the antenna using the linear radiation elements shown in FIG. 3a.

FIG. 4c is a diagram showing a reflection loss of the metal body antenna using the small-sized radiation elements shown in FIGS. 4a and 4b.

Referring to FIG. 4c, the range of an operating frequency in a low frequency band is from about 771 MHz to about 994 MHz based on a reflection loss −6 dB indicated by a solid line 401, and includes 824 MHz to 960 MHz, that is, the section of a frequency of GSM850 and EGSM. The range of an operating frequency in a high frequency band is from about 1678 MHz to about 2190 MHz based on a reflection loss −6 dB indicated by dotted lines 402, and includes 1710 MHz to 2170 MHz, that is, the section of a frequency of DCS, PCS or W2100.

FIGS. 5a and 5b are diagrams showing the structure of an antenna according to yet another embodiment of the present invention. FIG. 5a is a plan view showing a detailed and enlarged structure of a metal body antenna having small-sized loop type radiation elements in which the first end part 575a of a first radiation element 530a may be disposed at a specific location in the space between a connection line 550 and the end part 575a of a first side bezel unit 570a. FIG. 5b is a perspective view showing a detailed and enlarged structure of a metal body antenna having loop type radiation elements in which the first end part 575a of the first radiation element 530a may be disposed at a specific location in the space between the connection line 550 and the end part 575b of the first side bezel unit 570a.

In the metal body antenna having loop type radiation elements shown in FIGS. 5a and 5b according to an embodiment of the present invention, the first and the second radiation elements 530a and 530b have a small-sized linear structure, and a first bezel unit 560a and a second bezel unit 560b are supplied with an electromagnetic signal from the connection line 550 at a common location having the same start point.

Accordingly, the first radiation element 530a may be disposed at a specific location in the space between the connection line 550 and the end part 575a of the first side bezel unit 570a. The second radiation element 530b may be disposed at a specific location in the space between the connection line 550 and the end part 575b of the second side bezel unit 570b.

An operating principle of the metal body antenna using the small-sized radiation elements shown in FIGS. 5a and 5b is the same as that of the antenna using the linear radiation elements shown in FIG. 3a.

FIG. 5c is a diagram showing a reflection loss of the metal body antenna using the small-sized radiation elements shown in FIGS. 5a and 5b.

Referring to FIG. 5c, the range of an operating frequency in a low frequency band is from about 801 MHz to about 1063 MHz based on a reflection loss −6 dB indicated by a solid line 501, and includes 824 MHz to 960 MHz, that is, the section of a frequency of GSM850 and EGSM. The range of an operating frequency in a high frequency band is from about 1678 MHz to about 2176 MHz based on a reflection loss −6 dB indicated by dotted lines 502, and includes 1710 MHz to 2170 MHz, that is, the section of a frequency of DCS, PCS and W2100.

As described above, the metal body antenna having loop type radiation elements according to an embodiment of the present invention has an advantage in that it shows a wideband characteristic in the Penta Band (i.e., GSM850, EGSM, DCS, PCS, and W2100), that is, a band chiefly used in mobile phones because the metal body antenna has a multi-antenna structure of a wideband using the frame bezel unit and having a small radiation loss.

Furthermore, the metal body antenna having loop type radiation elements according to an embodiment of the present invention has an advantage in that it shows a wideband characteristic in multiple bands because the radiation element supplied with a signal from the feeding power port is not coupled to the frame bezel unit as a radiation element coupled to the ground, but the radiation element supplied with a signal from the feeding power port is coupled to the ground by loop coupling.

Furthermore, the metal body antenna having loop type radiation elements according to an embodiment of the present invention has an advantage in that it shows a wideband characteristic in multiple bands because the radiation element supplied with a signal from the feeding power port induces an electric current into the ground, magnetic energy is concentrated around the connection line that connects the ground and the upper bezel unit by a surface current flowing into the frame bezel unit as a radiation element connected to the ground by the electric current induced into the ground, and electric energy is concentrated on the open end part of the side bezel unit.

Furthermore, the metal body antenna having loop type radiation elements according to an embodiment of the present invention has an advantage in that it shows a wideband characteristic in multiple bands because the L-C element is inserted into the feeding power port and perfect impedance matching with the antenna unit is performed in an operating frequency band.

Although the embodiments of the present invention have been described in detail so far, it is evident that the embodiments are only illustrative, but are not limitative. It should be understood that a change of elements to the extent that the change may be equivalently handled without departing from the technical spirit or field of the present invention provided by the attached claims falls within the scope of the present invention.

What is claimed is:

1. A metal body antenna having loop type radiation elements, comprising:
a housing unit forming an external appearance of a terminal;
a first antenna unit having an electrical length of a half wavelength and comprising a first radiation element supplied with a signal of a low frequency band from a first feeding power port formed in the housing unit, a second radiation element supplied with a signal of a high frequency band from a second feeding power port formed in the housing unit, a ground coupled to the first and the second radiation elements by loop coupling and formed in the housing unit, a connection line connected to the ground, and a bezel unit connected to the connection line and opened by a gap; and
a second antenna unit having an electrical length of a half wavelength and comprising a bezel unit connected to the connection line and opened by a gap.

2. A metal body antenna having loop type radiation elements, comprising:
a radiation element supplied with a signal from a feeding power port;
a ground coupled to the radiation element by loop coupling to generate an induction current;
a frame bezel unit separated from the ground by a dielectric and a gap; and
a connection line configured to connect the ground and the frame bezel unit and formed over the dielectric so that an electric current induced into the ground flows into the frame bezel unit,
wherein a small-sized antenna having an electrical length of a half wavelength operates in a wideband.

3. A metal body antenna having loop type radiation elements, comprising:
a radiation element supplied with a signal from a feeding power port;
a ground coupled to the radiation element by loop coupling to generate an induction current;
a frame bezel unit separated from the ground by a dielectric and a gap; and
a connection line configured to connect the ground and the frame bezel unit and formed over the dielectric so that an electric current induced into the ground flows into the frame bezel unit,
wherein an antenna having an electrical length of a half wavelength operates in a wideband in multiple bands.

4. A metal body antenna having loop type radiation elements and operating in a wideband in multiple bands, the metal body antenna being formed in a housing unit of a terminal and comprising rectangular ground surfaces made of a metal material and a frame bezel unit surrounding outermost edge parts of the rectangular ground surfaces and having a frame made of metal,
wherein an upper frame bezel unit of the housing unit comprises an upper bezel unit and side bezel units,
the meal body antenna comprises:
gaps formed to maintain specific openings at locations of specific lengths from a top of the left and right side bezel units extended from end corner parts of the upper bezel unit to a bottom,
an upper frame bezel unit separated by the gaps,
dielectrics formed in a specific width between the rectangular ground surfaces, and
the upper bezel unit and the side bezel units of the left and right frames separated from a ground by the gaps and the dielectrics, and
the meal body antenna further comprises:
first and second feeding power ports formed in a specific portion adjacent to the dielectrics above the ground;
a first radiation element connected to the first feeding power port, supplied with an electromagnetic signal, and having an end part disconnected at a specific height with respect to the ground;
a second radiation element connected to the second feeding power port, supplied with an electromagnetic signal, and having an end part disconnected at a specific height with respect to the ground;
a connection line having an electromagnetic signal coupled to the first and the second radiation elements by loop coupling so that an induction current is generated in the ground formed below the first and the second radiation elements and connected to the ground in order to connect the ground and an upper bezel unit of the upper frame bezel unit separated by the gaps and the dielectrics; and
first and second antenna units each comprising a side bezel unit having an end part open by the gap from the upper bezel unit connected to the connection line.

5. A metal body antenna having loop type radiation elements and operating in a wideband in multiple bands, the metal body antenna comprising:
a housing unit forming an external appearance of a terminal;
first and second antenna units each having an electrical length of a half wavelength and comprising a first radiation element supplied with a signal of a low frequency band from a first feeding power port formed in the housing unit, a second radiation element supplied with a signal of a high frequency band from a second feeding power port formed in the housing unit, a ground coupled to the first and the second radiation elements by loop coupling and formed in the housing unit, a connection line connected to the ground, and frame bezel units connected to the connection line and opened by gaps; and
a separate gap formed in the open frame bezel unit, separating the open frame bezel unit and the connection line dually, and transferring an electromagnetic signal to the separated open frame bezel units through the separated connection lines.

6. A metal body antenna having loop type radiation elements and operating in a wideband in multiple bands, the metal body antenna comprising:
a housing unit of a terminal;
a metal frame bezel unit formed in an outskirt of the housing unit;
a first gap formed by cutting part of the frame bezel unit;
a ground separated from part of the frame bezel unit separated by the first gap at a specific interval;
a connection line comprising a second gap for separating the frame bezel unit separated by the first gap, electrically connecting part of the frame bezel unit separated by the second gap and the ground, and electrically connecting another part of the separated frame bezel unit and the ground;
first and second radiation elements coupled to the ground by electromagnetic loop coupling;
a first feeding power port formed in the housing unit, for applying a signal of a low frequency band to the first radiation element; and
a second feeding power port formed in the housing unit, for applying a signal of a high frequency band to the second radiation element,
wherein a signal subjected to electromagnetic loop coupling and transferred from the first radiation element to the ground is transmitted to the frame bezel unit separated by the first gap through the connection line so that electromagnetic waves are radiated, a signal subjected to electromagnetic loop coupling and transferred from the second radiation element to the ground is transmitted to another frame bezel unit separated by the second gap through the connection line so that electromagnetic waves are radiated.

7. A metal body antenna having loop type radiation elements and operating in a wideband in multiple bands, the metal body antenna comprising:
a terminal housing unit;
a metal frame bezel unit formed in an outskirt of the terminal housing unit;
a gap formed by cutting part of the frame bezel unit;
a ground electrically connected to the frame bezel unit separated by the gap and spaced apart from part of the frame bezel unit comprising the gap at a specific interval;
a connection line connected to the ground;
first and second radiation elements formed in the ground and coupled to the ground by electromagnetic loop coupling;
a first feeding power port formed in the terminal housing unit, for applying a signal of a low frequency band to the first radiation element; and
a second feeding power port formed in the terminal housing unit, for applying a signal of a high frequency band to the second radiation element.

8. A metal body antenna having loop type radiation elements and operating in a wideband in multiple bands, the metal body antenna comprising:
a terminal housing unit;
a metal frame bezel unit formed in an outskirt of the terminal housing unit;
a gap formed by cutting part of the frame bezel unit;
a ground spaced apart from part of the frame bezel unit separated by the gap at a specific interval;
a connection line connected to the ground, wherein part of the other side of the frame bezel unit on one side separated by the gap and the ground are connected, and part of the other side of the frame bezel unit on the other side separated by the gap and the ground are connected;
first and second radiation elements coupled to the ground by electromagnetic loop coupling;
a first feeding power port formed in the terminal housing unit, for applying a signal of a low frequency band to the first radiation element; and
a second feeding power port formed in the terminal housing unit, for applying a signal of a high frequency band to the second radiation element,
wherein a signal subjected to electromagnetic loop coupling and supplied from the first radiation element to the ground is transmitted to one frame bezel unit separated by the gap connected to the ground and radiated, and a signal subjected to electromagnetic loop coupling and supplied from the second radiation element to the ground are transmitted to the other frame bezel unit separated by the gap connected to the ground and radiated.

9. The metal body antenna of claim 1, wherein the first radiation element and the second radiation element are formed on both sides of the ground based on the connection line and operate in a wideband in multiple bands.

10. The metal body antenna of claim 2, wherein the first radiation element and the second radiation element are formed on both sides of the ground based on the connection line and operate in a wideband in multiple bands.

11. The metal body antenna of claim 3, wherein the first radiation element and the second radiation element are formed on both sides of the ground based on the connection line and operate in a wideband in multiple bands.

12. The metal body antenna of claim 4, wherein the first radiation element and the second radiation element are formed on both sides of the ground based on the connection line and operate in a wideband in multiple bands.

13. The metal body antenna of claim 5, wherein the first radiation element and the second radiation element are formed on both sides of the ground based on the connection line and operate in a wideband in multiple bands.

14. The metal body antenna of claim 6, wherein the first radiation element and the second radiation element are formed on both sides of the ground based on the connection line and operate in a wideband in multiple bands.

15. The metal body antenna of claim 7, wherein the first radiation element and the second radiation element are formed on both sides of the ground based on the connection line and operate in a wideband in multiple bands.

16. The metal body antenna of claim 8, wherein the first radiation element and the second radiation element are formed on both sides of the ground based on the connection line and operate in a wideband in multiple bands.

17. The metal body antenna of claim 1, wherein an L-C element is inserted between the first and the second feeding power ports and the first and the second radiation elements so that impedance is matched and the first and the second radiation elements operate in a wideband in multiple bands.

18. The metal body antenna of claim 2, wherein an L-C element is inserted between the first and the second feeding power ports and the first and the second radiation elements so that impedance is matched and the first and the second radiation elements operate in a wideband in multiple bands.

19. The metal body antenna of claim 3, wherein an L-C element is inserted between the first and the second feeding power ports and the first and the second radiation elements so that impedance is matched and the first and the second radiation elements operate in a wideband in multiple bands.

20. The metal body antenna of claim 4, wherein an L-C element is inserted between the first and the second feeding power ports and the first and the second radiation elements so that impedance is matched and the first and the second radiation elements operate in a wideband in multiple bands.

21. The metal body antenna of claim 5, wherein an L-C element is inserted between the first and the second feeding power ports and the first and the second radiation elements so that impedance is matched and the first and the second radiation elements operate in a wideband in multiple bands.

22. The metal body antenna of claim 6, wherein an L-C element is inserted between the first and the second feeding power ports and the first and the second radiation elements so that impedance is matched and the first and the second radiation elements operate in a wideband in multiple bands.

23. The metal body antenna of claim 7, wherein an L-C element is inserted between the first and the second feeding power ports and the first and the second radiation elements so that impedance is matched and the first and the second radiation elements operate in a wideband in multiple bands.

24. The metal body antenna of claim 8, wherein an L-C element is inserted between the first and the second feeding power ports and the first and the second radiation elements so that impedance is matched and the first and the second radiation elements operate in a wideband in multiple bands.

25. The metal body antenna of claim 1, wherein the radiation element coupled to the ground by loop coupling has a small size and disposed at a specific location in a space between the end part of the frame bezel unit and the connection line.

26. The metal body antenna of claim 2, wherein the radiation element coupled to the ground by loop coupling has a small size and disposed at a specific location in a space between the end part of the frame bezel unit and the connection line.

27. The metal body antenna of claim 3, wherein the radiation element coupled to the ground by loop coupling has a small size and disposed at a specific location in a space between the end part of the frame bezel unit and the connection line.

28. The metal body antenna of claim 4, wherein the radiation element coupled to the ground by loop coupling has a small size and disposed at a specific location in a space between the end part of the frame bezel unit and the connection line.

29. The metal body antenna of claim 5, wherein the radiation element coupled to the ground by loop coupling has a small size and disposed at a specific location in a space between the end part of the frame bezel unit and the connection line.

30. The metal body antenna of claim 6, wherein the radiation element coupled to the ground by loop coupling has a small size and disposed at a specific location in a space between the end part of the frame bezel unit and the connection line.

31. The metal body antenna of claim 7, wherein the radiation element coupled to the ground by loop coupling has a small size and disposed at a specific location in a space between the end part of the frame bezel unit and the connection line.

32. The metal body antenna of claim 8, wherein the radiation element coupled to the ground by loop coupling has a small size and disposed at a specific location in a space between the end part of the frame bezel unit and the connection line.
